(19) United States
(12) Patent Application Publication
(10) Pub. No.: US 2005/0050970 A1
(43) Pub. Date: Mar. 10, 2005

(54) Cap assembly for sealing system and method of assembling same

(75) Inventors: Samuel Roland Palfenier, El Paso, TX (US); Manuel A. Quintana, Juarez (MX); Clemente Marquez, Juarez (MX)

Correspondence Address: JIMMY L. FUNKE;DELPHI TECHNOLOGIES, INC., Legal Staff, Mail Code: 480-410-202, P.O. Box 5052, Troy, MI, 48007-5052, US

(73) Assignee: DELPHI TECHNOLOGIES, INC., TROY, MI (US)

(21) Appl. No.: 10/657,765

(22) Filed: Sep. 8, 2003

(51) Int. Cl. G01D 21/00

(52) U.S. Cl. 73/866.5; 60/552; 60/585; 73/116

(57) ABSTRACT

A cap assembly (10) is used during the assembly of a sensor (22) that is to be mounted to a support (30). The support (30) will eventually be mounted to a structure (16) that will hold a fluid therein. Epoxy (56) holds the sensor (22) to the support (30). The cap assembly (46) includes a body (48) having a predetermined length and a shape matching the shape of the support (30). This allows the body (48) to be removably securable to the support (30). The cap assembly (46) also includes an end plate (50) covering the body (48) to prevent epoxy (56) from flowing passed the cap assembly (46). The cap assembly (46) also includes a handle (52) for removing the cap assembly (46) from the support (30) when the epoxy (56) has cured.

### BACKGROUND ART

1. Field of the Invention

The invention relates to cap assemblies for sensors that are adhered to support structures. More specifically, the invention relates to cap assemblies used to position and seal sensor assemblies within their support structures for subsequent emersion of the sensor assembly into a liquid environment.

2. Description of the Related Art

Oftentimes, sensors are placed in hostile environments. Sensors placed in the automotive environment must operate through extreme temperature ranges, vibrations created by the internal combustion engine and jarring movement of the automobile as it drives over poor road conditions. Maintaining a sensor's operability in these conditions is compounded when the sensor is placed in a fluid, e.g., a transmission casing, an oil pan, a radiator, and the like. Not only must the sensor withstand large temperature swings and the vibrations set forth above, but the sensor must also be able to do so while maintaining itself in a leak-proof casing.

Many sensors are also being converted from an analog technology to a digital technology. Because the digital sensor technology is new, however, new challenges must be addressed in order to use the digital sensors in the presence of these liquids. These liquids can degrade the materials of the sensing devices. In particular, transmission fluid has been determined to be harmful to the internal components of the sensing array for a Hall-effect digital velocity sensor. While the plastic cover for the Hall-effect sensor device is capable of being exposed to the transmission fluid, the componentry behind the plastic cover is susceptible to the corroding effects of the transmission fluid. In addition, digital transmission sensors such as the Hall-effect digital velocity sensor, must be exposed to the transmission fluid in order to properly sense the parameters for which the sensor is placed within the transmission casing. Therefore, any casing to protect the componentry of the sensors cannot cover the sensor face.

### SUMMARY OF THE INVENTION

A cap assembly is used during the assembly of a sensor that is to be mounted to a support. The support will eventually be mounted to a structure that will hold a fluid therein. Epoxy holds the sensor to the support. The cap assembly includes a body having a predetermined length and a shape matching the shape of the support. This allows the body to be removably securable to the support. The cap assembly also includes an end panel covering the body to prevent epoxy from flowing passed the cap assembly. The cap assembly also includes a handle for removing the cap from the support when the epoxy has cured.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a side view of a transmission, partially cut away, showing the sensor secured thereto;

FIG. 2 is a perspective view of a sensor assembly and its electrical leads, partially cut away;

FIG. 3 is a perspective view of an insert for the sensor;

FIG. 4 is a perspective view of the sensor assembly and the cap assembly mounted to the support;

FIG. 5 is an exploded view of the cap assembly and the support, partially cut away; and

FIG. 6 is a perspective view of a cap assembly according to one embodiment of the invention.

### DETAILED DESCRIPTION OF THE PREFERRED EMBODIMENT

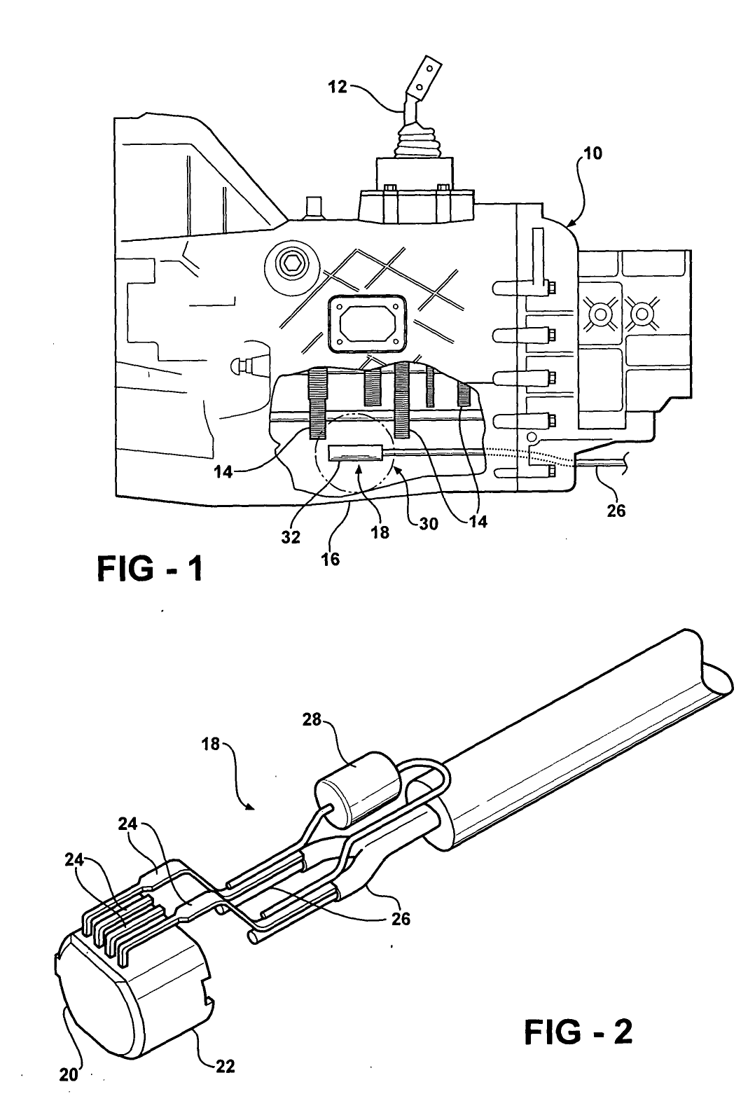

Referring to FIG. 1, a transmission 10 is shown having a shifter 12 and a plurality of gears 14 inside a transmission casing 16. Fluid fills the transmission casing 16 to lubricate and cool the gears 14 as they work. A sensor assembly generally indicated at 18 is secured to an inside wall of the transmission casing 16. It should be appreciated by those skilled in the art that the sensing assembly 18 is being shown secured within a transmission 10 for exemplary purposes only and that the sensing assembly 18 may be placed in any environment, automotive or non-automotive, that requires a sensor to be sealed from its environment and to its support structure.

Referring to FIG. 2, the sensing assembly 18 is shown to have a sensing cover 20 that is to be exposed to the fluid within the transmission 10. A digital array 22 is disposed adjacent to the sensing cover 20. The digital array 22 is designed to measure the parameters for which the sensing assembly 18 is placed in its hostile environment. Electrical leads 24 extend outside the digital array 22 and extend backward toward electrical wires 26 that transmit the signals created by the digital array 22 to a controlled circuit (not shown) for subsequent analysis, computation and/or display thereof. A capacitor 28 is shown in parallel to two of the electrical leads 24 as it is secured between the leads 24 and the electrical wires 26.

Referring to FIG. 4, a support is generally shown at 30. The support 30 includes a portion that is a support receptacle 32, which receives the sensor assembly 18 therein. The support receptacle 32 is mounted to a support plate 34 via an extension 35. The support plate 34 is mounted to the transmission casing 16 through suitable rivets through fastener receiving holes 36 (one shown). In the embodiment shown in the Figures, the support receptacle 32 is cylindrical in shape.

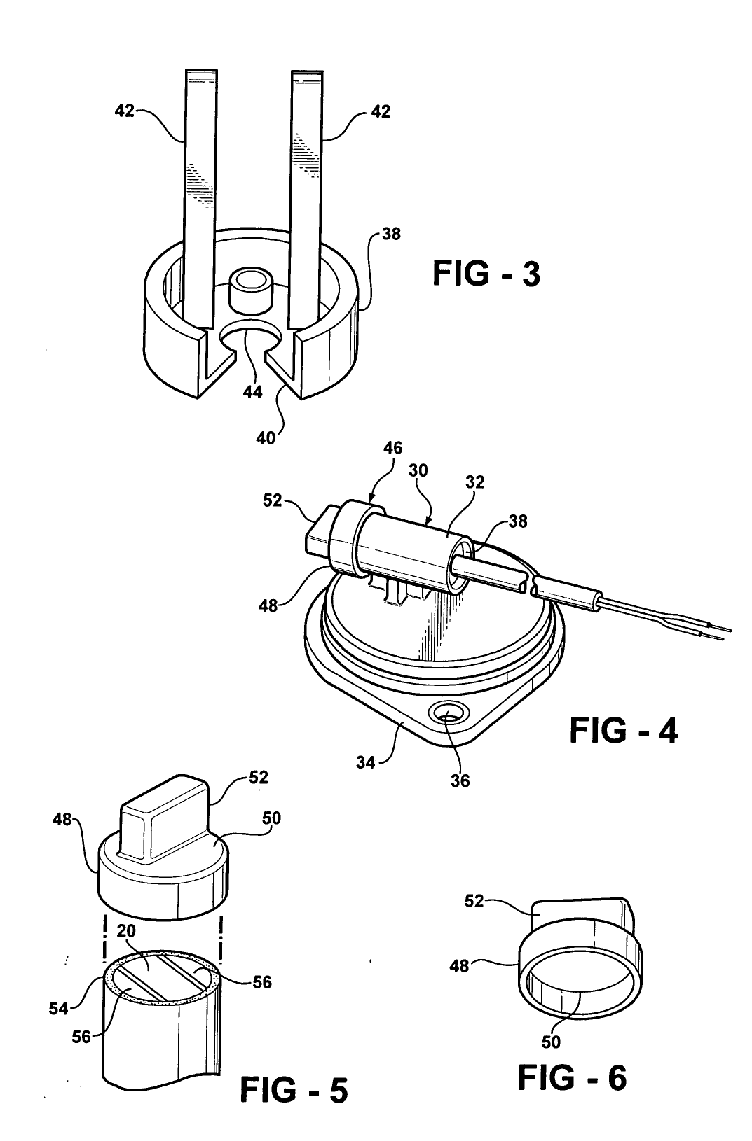

Referring to FIG. 3, an insert 38 is shown to have an insert disc 40 and two legs 42 extending out therefrom. The insert disc 40 includes a receiving aperture 44 that is designed to receive the electrical wires 26 therein. Returning attention to FIG. 4, the insert 38 is placed into the support receptacle 32 covering the back end of the support receptacle 32 opposite of the front end of the support receptacle 32, where the sensing cover 20 is exposed.

A cap assembly 46 is placed over the front end of the support receptacle 32 during the construction of the sensor assembly 18. The cap assembly 18 includes a body 48 having a predetermined length. The body 48 has a shape that matches the support 30 such that the body 48 is removably securable to the support 30. More specifically, in the example shown in the Figures, the body 48 of the cap assembly 46 is cylindrical designed to match the support receptacle 32.

The cap assembly 46 also includes an end plate 50. The end plate covers the body 48 such that the cap assembly 46 acts as a lid and seals the support receptacle 32 at the end where the sensing cover 20 extends.

The cap assembly also includes a handle 52 that is fixedly secured to the end plate 50. The handle 52 extends out from the end plate 50 opposite the direction that the body 48 extends from the end plate 50. The handle 52 is used to remove the cap assembly 46 from the support receptacle 32 at the appropriate time. The handle 52 extends across the body 48. The cap assembly 46 is fabricated from a mold-making silicone. In particular, a premium grade KE1311T mold-making silicone is a material used in the preferred embodiment.

The method for assembling the sensor assembly 18 includes the step of fitting the cap assembly 46 over the support 30. The cap assembly 46 must be forced over the support receptacle 32 to provide a seal for the support receptacle 32 at that end. The cap assembly 46 is forced over the support receptacle 32 sufficiently such that all of the body 48 covers the support receptacle 32. This also means the end plate 50 abuts a cylinder end 54 of the support receptacle 32.

Once the cap assembly 46 is in place, the sensor assembly 18 is placed into the support receptacle 32. Once the sensor assembly 18 is inserted into the support receptacle 32 sufficiently such that the sensor cover 20 abuts the end plate 50 of the cap assembly 46, the support 30 and the sensor assembly 18 are inverted to create a cup effect allowing the support receptacle 32 and the cap assembly 46 to retain an epoxy therein.

The support receptacle 32 is then filled with an epoxy while the sensor assembly 18 is in place. A typical epoxy that is used in these situations is an epoxy marketed under the trade name Epocap 19284. This material can withstand temperatures of up to 150° C. The Epocap 19284 epoxy does not bond with the above-identified silicone used to fabricate the cap assembly 46. This allows the cap assembly 46 to be removed upon the curing of the epoxy. Once the epoxy, generally indicated at 56 in FIG. 5, is cured, the cap assembly 46 may be removed.

Prior to the curing of the epoxy -56, the insert 38 is forced into the support receptacle 32 with the legs 42 leading. The insert 38 forces the sensor cover 20 into an abutting relationship with the end plate 50 of the cap assembly 46. Access is provided for the electrical wires 26 via the receiving aperture 44 of the insert disc 40.

Prior to removal of the cap assembly 46, the epoxy 56 is cured by heating the epoxy 56 to 100° C. The epoxy 56 is heated at this temperature for approximately 20 to 30 minutes. Once the epoxy 56 has cured, the cap assembly 46 is removed allowing the sensor cover 20 to be exposed to the fluid within the transmission 10 without exposing the components of the sensor assembly 18 thereto.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A cap assembly (46) for use with a sensor assembly (18) that is mounted to a support (30) using an epoxy (56) to hold the sensor assembly (18) to the support (30), said cap assembly (46) comprising:
a body (48) having a predetermined length and a shape matching a shape of a portion (32) the support (30) such that said body (98) is removably securable to the support (30);
an end plate (50) covering said body (48) preventing the epoxy (56) from flowing therepast; and
a handle (52) for removing said cap assembly (46) from the support (30) when the epoxy (56) has cured.

2. A cap assembly (46) as set forth in claim 1 wherein said handle (52) is fixedly secured to said end plate (50).

3. A cap assembly (46) as set forth in claim 2 wherein said handle (52) extends across said body (48).

4. A cap assembly (46) as set forth in claim 3 wherein said handle (52) is rectangular in shape.

5. A method for assembling a sensor assembly (18) for use in a reservoir of fluid by securing a sensor (22) to a support (30) with an epoxy (56) using a cap assembly (46), the method including the steps of:
fitting the cap assembly (46) over the support (30);
inserting the sensor assembly (18) into the support (30);
rotating the support (30) until the cap assembly (46) is below the sensor (22);
filling the support (30) with epoxy (56);
curing the epoxy (56); and
removing the cap assembly (46).

6. A method as set forth in claim 5 wherein the step of insert the sensor (22) into the support (30) includes the step of abutting the sensor (22) against the cap assembly (46).

7. A method as set forth in claim 6 including the step of mounting the support (30) within a reservoir after the step of removing the cap assembly (46).

8. A method as set forth in claim 7 including the step of centering the sensor (22) inside the support (30) before the step of filling the support (30) with the epoxy (46).

9. A method as set forth in claim 8 including the step of curing the epoxy (56) by heating the epoxy (56) to 100° C.

10. A method as set forth in claim 9 including the step of curing the epoxy (56) for a time in a range between twenty minutes and thirty minutes.
